(19) United States
(12) Patent Application Publication
(10) Pub. No.: US 2026/0031253 A1
(43) Pub. Date: Jan. 29, 2026

(54) ANTI-THEFT BARRIER FOR ELECTRIC CABLES

(71) Applicant: K.W.D. Automotive, Inc. dba CatStrap, Whitehouse, OH (US)

(72) Inventors: David Thomas Birsen, Alexandria, VA (US); Thomas Birsen, Waterville, OH (US)

(73) Assignee: K.W.D. Automotive, Inc. dba CatStrap, Whitehouse, OH (US)

(21) Appl. No.: 19/279,417

(22) Filed: Jul. 24, 2025

Related U.S. Application Data
(60) Provisional application No. 63/676,096, filed on Jul. 26, 2024.

(51) Int. Cl. H01B 7/24; B60L 53/18; H01B 7/22; H01B 7/36; H01B 13/22

(52) U.S. Cl. CPC H01B 7/24; B60L 53/18; H01B 7/225; H01B 7/36; H01B 13/22; B60L 2270/34

(57) ABSTRACT

A flexible anti-theft protection system for an elongated cable is disclosed. The system comprises a plurality of elongate flexible armor elements disposed parallel to a longitudinal axis of the cable and arranged circumferentially around the cable. A plurality of compressible guide-channel bands are spaced along a length of the cable, each band comprising longitudinal guide channels configured to receive and maintain circumferential positioning of the armor elements. The guide-channel bands are configured to compress radially inward to accommodate cables of varying diameters. The invention also encompasses a method of installing the anti-theft protection system comprising positioning the plurality of elongate flexible armor elements circumferentially around the cable, securing the armor elements using compressible guide-channel bands having longitudinal guide channels that maintain circumferential positioning of the armor elements, and compressing each guide-channel band radially inward against the cable using a fastening member.

### CROSS-REFERENCE TO RELATED APPLICATIONS

This application claims the benefit of priority under 35 U.S.C. § 119 (e) to U.S. Provisional Application Ser. No. 63/676,096, entitled “FLEXIBLE CUTTING BARRIER FOR ELECTRIC CABLES” filed Jul. 26, 2024, the contents of which are incorporated herein by reference in their entirety.

### TECHNICAL FIELD

The present disclosure relates generally to protective enclosures for electric vehicle charging infrastructure and, more particularly, to a flexible anti-theft barrier system configured to deter or prevent cutting of exposed electric cables using hand tools or power tools.

### BACKGROUND

Electric vehicle (EV) adoption has led to widespread deployment of EV charging stations in both public and private spaces. These stations commonly feature long, high-current charging cables that are subject to regular handling, exposure to environmental elements, and, increasingly, acts of vandalism and theft. Because EV cables contain valuable copper wiring, they have become a frequent target for theft, particularly in unattended public locations.

Standard EV charging cables are typically constructed with a polymeric outer jacket over insulated conductors, which provides limited resistance to physical tampering. Thieves can often sever such cables using common cutting tools such as bolt cutters, hacksaws, or abrasive disc grinders. The resulting damage not only disables the charging station but also creates safety risks, repair costs, and service disruptions for EV users.

While various protective solutions have been attempted, including but not limited to, rigid conduit enclosures, armored cables, or bollard-protected layouts—many of these approaches are either cost-prohibitive, difficult to retrofit onto existing infrastructure, or overly restrictive to cable flexibility and user ergonomics. Rigid enclosures may also interfere with the natural coiling, extension, or retraction of the charging cable during regular use.

Some cable manufacturers have introduced internal armoring or tamper-evident jackets, but these modifications can significantly increase cable weight, reduce flexibility, and complicate maintenance or replacement. Additionally, integrated armored cables must be installed at the factory level and are not easily adapted to the thousands of existing installations already in service.

There remains a need for a lightweight, retrofittable, and cost-effective solution that provides physical cut resistance along the length of a charging cable while preserving its flexibility and functional range of motion. Such a solution should be compatible with cables of varying diameters, should not interfere with charging operations, and should be installable on-site without requiring specialized tools or the removal of the charging cable from service.

There is particular interest in developing flexible protective systems that utilize hardened materials in a modular fashion to create a dynamic but continuous cut barrier. In addition to physical reinforcement, the solution may benefit from visual deterrents and optional tamper-indication features that further discourage theft attempts and simplify enforcement or maintenance response.

### SUMMARY OF THE INVENTION

A flexible anti-theft protection system for an elongated cable comprises a plurality of elongate flexible armor elements disposed parallel to a longitudinal axis of the cable and arranged circumferentially around the cable, wherein the armor elements include at least one metal element. The system includes a plurality of compressible guide-channel bands spaced along a length of the cable, each band comprising longitudinal guide channels configured to receive and maintain circumferential positioning of the armor elements. The guide-channel bands are configured to compress radially inward to accommodate cables of varying diameters.

In one embodiment, the plurality of armor elements are arranged equidistantly around a circumference of the cable.

In one embodiment, the armor elements comprise at least two different materials having distinct mechanical properties.

In one embodiment, the at least two different materials comprise hardened steel strips and aircraft cable elements.

In one embodiment, at least four hardened steel strips and at least four aircraft cable elements are arranged in an alternating pattern around the cable circumference.

In one embodiment, the system further comprises a pressurized dye reservoir disposed along the cable and configured to release dye when breached.

In one embodiment, the guide-channel bands permit axial sliding movement of the armor elements relative to the cable to accommodate bending of the cable.

In one embodiment, each guide-channel band comprises a fabric material with loop structures configured to receive the armor elements.

In one embodiment, each hardened steel strip has a Rockwell C-scale hardness ranging between 50 to 60 HRC per ASTM E18.

In one embodiment, the system further comprises terminal retention structures configured at opposite ends of the cable.

In one embodiment, the system further comprises an outer jacket enclosing the armor elements and guide-channel bands, wherein the armor elements comprise flexible metal strips disposed parallel to the longitudinal axis and the guide-channel bands permit axial sliding movement of the metal strips relative to the cable.

In one embodiment, the metal strips alternate with aircraft-cable wires that are interleaved between adjacent metal strips.

In one embodiment, each guide-channel band further comprises a fastening member for securing the band around the cable.

A method of installing an anti-theft protection system on a cable comprises positioning a plurality of elongate flexible armor elements circumferentially around the cable, securing the armor elements using compressible guide-channel bands having longitudinal guide channels that maintain circumferential positioning of the armor elements, and compressing each guide-channel band radially inward against the cable using a fastening member.

In one embodiment, the armor elements comprise at least two different materials having distinct mechanical properties.

In one embodiment, the fastening member comprises an embedded cable tie.

In one embodiment, the method further comprises installing an outer jacket over the armor elements and guide-channel bands.

### BRIEF DESCRIPTION OF THE DRAWINGS

FIG. 1 is a perspective view of a flexible anti-theft protection system installed on an electric vehicle charging station cable in an operational environment according to an embodiment of the present disclosure.

FIG. 2 is a cross-sectional view of the cable protection system showing the arrangement of armor elements and compressible guide-channel bands in their operational configuration according to an embodiment of the present disclosure.

FIG. 3 is a schematic view of the cable protection system showing the internal construction and arrangement of armor elements within a compressible guide-channel band applied onto a cable according to an embodiment of the present disclosure.

FIG. 4 is a perspective view of the cable protection system in an installed configuration showing the complete system extending along the length of the cable in a curved or bent orientation according to an embodiment of the present disclosure.

FIG. 5 is an internal view of an outer jacket showing the arrangement and positioning of hardened metal elements within the protective system according to an embodiment of the present disclosure.

FIG. 6 is a perspective view of the tubular structure of the outer jacket in a partially opened configuration, demonstrating the internal construction and arrangement of armor elements according to an embodiment of the present disclosure.

FIG. 7 is a flowchart illustrating a method of installing the flexible anti-theft protection system on a cable according to an embodiment of the present disclosure.

FIG. 8 is a perspective view of the low-profile clamp positioned at the equipment end of the cable installation, demonstrating flush termination characteristics according to an embodiment of the present disclosure.

FIG. 9 is a detailed view of the terminal retention structure and fastening mechanism, illustrating the integration between the low-profile clamp and the fastening elements according to an embodiment of the present disclosure.

### DETAILED DESCRIPTION OF EXAMPLE EMBODIMENTS

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

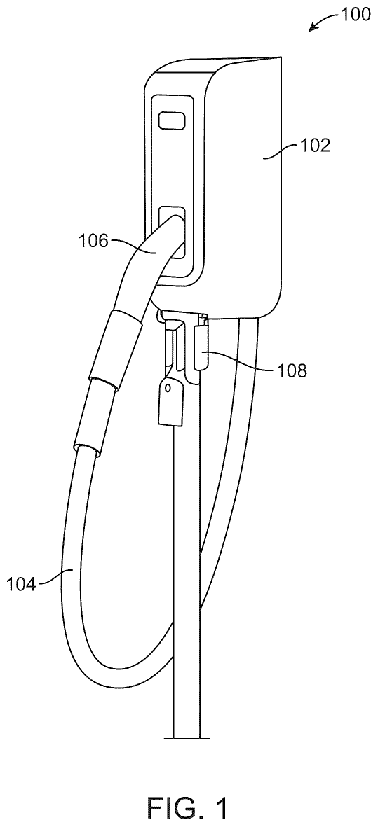

FIG. 1 illustrates a flexible anti-theft protection system installed on an electric vehicle charging station cable in an operational environment (100), in accordance with an embodiment of the present subject matter. As shown in FIG. 1, a charging station housing (102) contains the charging electronics and user interface components. A charging cable (104) extends from the charging station housing (102) and terminates at a charging connector (106) configured to mate with an electric vehicle charging port.

The cable protection system (108), in accordance with an embodiment of the present subject matter, is installed along a portion of the charging cable (104) between the charging station housing (102) and the charging connector (106). The protection system (108) may be a cylindrical or tubular structure that encases the underlying charging cable (104). The protection system (108) maintains the general cylindrical profile of the original cable while providing an additional protective layer around the cable's exterior surface.

The charging station housing (102) is mounted in a vertical orientation and includes a user interface panel on its front surface. The housing (102) provides structural support for the charging cable (104) at the point where the cable exits the housing. The cable (104) extends downward from the housing (102) in a generally curved configuration, demonstrating the flexibility of both the underlying cable and the protective system (108).

The charging connector (106) is positioned at a distal end of the cable (104) opposite from the charging station housing (102). The connector (106) includes the electrical contacts and mechanical features necessary to establish both electrical connection and physical retention with a mating charging port on an electric vehicle.

The protection system (108) extends along a substantial portion of the cable length, covering the section most vulnerable to theft attempts. The system (108) appears to maintain uniform cross-sectional dimensions along its length, indicating consistent protection coverage. The surface of the protection system (108) exhibits a smooth, continuous appearance without visible gaps or discontinuities that might compromise the protective function.

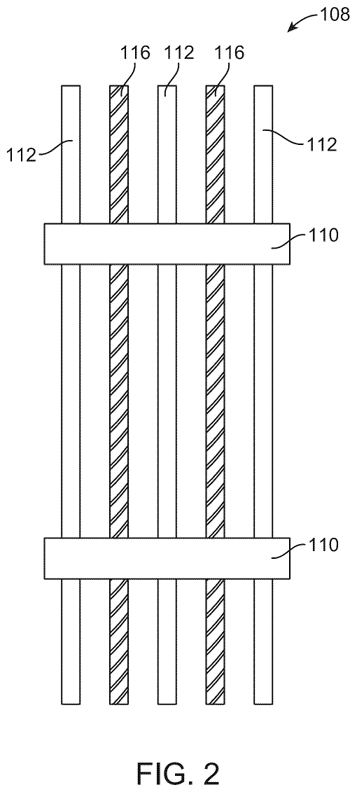

FIG. 2 illustrates a cross-sectional view of the cable protection system (108) showing the arrangement of armor elements and compressible guide-channel bands (110) in their operational configuration. FIG. 2 depicts a plurality of elongate flexible armor elements arranged parallel to a longitudinal axis of the cable (104) and configured for being positioned circumferentially around the cable (104).

The armor elements include hardened metal elements (112) that extend longitudinally along the cable length. The metal elements (112) are disposed in a generally flat, elongated configuration and are positioned at spaced intervals around the circumference of the cable. While the illustrated embodiment shows hardened spring steel, it should be understood that the metal elements (112) may alternatively comprise other hardened metal materials including but not limited to tool steel, carbon steel, stainless steel, or specialty alloy compositions having equivalent or superior hardness characteristics. The hardness values may range from approximately 40 HRC to 65 HRC, though values outside this range are contemplated without departing from the scope of the invention.

To resist cutting, hardened metal materials must exhibit high surface hardness, tensile strength, wear resistance, and often toughness, depending on the cutting threat (e.g., bolt cutters, angle grinders, saws). In certain embodiments, the cable, armor, or structural elements may be fabricated from metallic materials selected or treated to resist cutting forces through mechanical hardness, abrasion resistance, and deformation resistance. The following hardened metal materials may be employed, individually or in combination, depending on the desired balance of cut resistance, toughness, corrosion resistance, and manufacturability.

One suitable class of materials includes hardened carbon steels, particularly medium- and high-carbon grades such as AISI 1055, 1075, and 1095. These steels, when subjected to appropriate heat treatments such as quenching and tempering, may exhibit surface hardness in the range of 50 to 65 on the Rockwell C scale (HRC). Such hardness values exceed the cutting capacity of standard hand tools, including bolt cutters and hack saws, particularly when used in cross-sectional thicknesses of 6 mm or greater.

Another appropriate material is alloy steel, including grades such as AISI 4140, 4340, or 8620, which can be induction-hardened or carburized to produce a hardened outer shell while maintaining core ductility. These steels can be tailored to achieve case depths of 0.5 to 2.0 mm with surface hardness values exceeding 55 HRC, allowing them to resist both mechanical shearing and sawing attempts.

In high-security applications, tool steels such as D2, S7, or M2 may be used. Tool steels are characterized by their high carbon and alloy content, which allow them to be hardened to surface hardness levels of 58 to 64 HRC and retain this hardness under thermal and mechanical stress. For example, D2 tool steel is a high-carbon, high-chromium steel that offers excellent wear resistance and edge-holding capability, making it highly effective in defeating manual and power cutting tools.

Maraging steels, such as 18Ni(300), may also be employed for their unique combination of ultra-high tensile strength (exceeding 2000 MPa) and toughness. These steels are precipitation hardened and do not rely on high carbon content, resulting in excellent dimensional stability and resistance to both impact and sustained mechanical loading. While their Rockwell hardness typically ranges from 50 to 55 HRC, their resistance to plastic deformation makes them effective in resisting blade intrusion.

Another class of materials suitable for cut-resistant applications includes stainless steels, particularly martensitic grades such as 440C, 420HC, or 17-4PH. These steels can be heat-treated to hardness values of 50 to 60 HRC while providing corrosion resistance, making them suitable for outdoor or marine security uses.

In some embodiments, tungsten carbide or cemented carbide alloys may be used as inserts, coatings, or embedded particles within a composite cable structure. Tungsten carbide is an extremely hard material (typically 70 to 90 HRC equivalent) with exceptional wear resistance, often used in armor applications or to blunt cutting tools by causing chipping or tool failure.

Additional materials may include boron steel, which, after proper heat treatment, can achieve very high surface hardness (up to 60 HRC) and is commonly used in anti-theft devices and structural reinforcements. Nitrided steel or steels treated with surface-hardening processes such as plasma nitriding or boriding can also be employed to create an extremely hard surface layer (typically >1000 Vickers Hardness, or roughly 60-70 HRC equivalent) with excellent wear resistance.

Aircraft cable elements (116) are interspersed between the hardened metal elements (112). The aircraft cable elements (116) comprise flexible wire rope construction that provides resistance to different types of cutting tools compared to the metal elements. While the illustrated embodiment shows aircraft cable construction, alternative embodiments may employ other flexible metal cable types including but not limited to galvanized wire rope, stainless steel cable, braided metal strands, or composite cable constructions incorporating metal fibers. The aircraft cable elements (116) maintain their longitudinal orientation parallel to the cable axis while offering flexibility for cable bending. The cable construction may vary in strand count, core configuration, and material composition without limitation.

In certain embodiments, the cable may be formed from hardened steel materials specifically selected or treated to provide resistance to cutting or severing attempts using common tools such as bolt cutters, hand saws, or grinding implements. One such configuration employs case-hardened steel cables, wherein the outer surface of the steel strands undergoes a thermochemical treatment, such as carburizing or nitriding, followed by quenching and tempering. This process results in a surface hardness typically in the range of 45 to 60 on the Rockwell C scale (HRC), while the core remains relatively ductile to preserve tensile strength and flexibility. The hardened outer shell exhibits sufficient hardness to blunt or fracture conventional cutting tools upon contact, thereby increasing the time, effort, and tool wear required to compromise the cable.

An alternative embodiment utilizes an armored steel cable construction, in which a central core of wire rope is enclosed within a sheath of interlocking or overlapping steel segments or sleeves. These armored segments are fabricated from tool-grade or spring-grade hardened steel, often treated to achieve surface hardness levels in excess of 50 HRC. The armor components are configured to shift or rotate slightly under localized pressure, which interferes with the alignment and penetration of bolt cutter jaws or saw blades. The combined effect of high surface hardness and mechanical instability under pressure presents a significant barrier to unauthorized severing.

In other embodiments, the security cable comprises high-tensile strength wire strands formed from galvanized or stainless steel alloys. The wires may be arranged in multi-strand configurations, such as 7×7 or 7×19 constructions, with individual wires having tensile strengths exceeding 1600 MPa and surface hardness values in the range of 30 to 45 HRC. These cables exhibit both high flexibility and improved resistance to shearing and tensile fracture, particularly when produced with diameters greater than 10 millimeters. Increased cross-sectional area and mechanical interlocking of multiple strands further hinder localized cutting attempts.

Additional embodiments may include composite security cables incorporating both metallic and non-metallic materials. For example, a steel wire strand may be interwoven or co-extruded with a core comprising aramid fiber, such as Kevlar, which is known for its exceptional tensile strength and resistance to cutting and abrasion. The steel component may be hardened to levels of 50 HRC or greater, while the aramid component resists slicing by friction-based tools. The resulting composite structure provides enhanced resistance to a wide variety of cutting techniques by combining the wear hardness of steel with the fiber's resistance to tensile rupture and sawing.

In all configurations, the security cable may be further encased in a protective outer layer formed from a polymeric sheath, such as polyvinyl chloride (PVC) or nylon. The sheath serves to obscure the internal cable geometry, deter tampering, and resist surface degradation from environmental exposure, chemicals, or light mechanical abrasion. In some cases, the sheath may incorporate embedded materials or additives to enhance cut or flame resistance.

In certain embodiments, the polymeric outer sheath of the security cable may be formulated with embedded materials or additives selected to increase resistance to physical cutting, slashing, melting, or ignition. These enhancements may be achieved through the incorporation of high-modulus inorganic fillers, heat-resistant fibers, flame retardants, and cross-linking agents within the polymer matrix of the sheath material.

For increased cut resistance, the sheath may include embedded glass fibers, ceramic particles, basalt fibers, or alumina (Al₂O₃) whiskers, which serve to harden the sheath surface and disrupt the progression of blades or abrasive edges. The inclusion of such hard particulates increases the abrasive wear resistance of the sheath and causes accelerated dulling or deflection of cutting implements. In some embodiments, the sheath may be reinforced with woven or braided high-strength fibers, such as aramid (e.g., Kevlar®) or ultra-high-molecular-weight polyethylene (UHMWPE) filaments, which are embedded within or bonded to the outer layer to form a cut-resistant mesh or grid.

To enhance flame resistance, the sheath formulation may include intumescent additives, halogenated flame retardants, phosphorus-based flame retardants, aluminum hydroxide (ATH), magnesium hydroxide (MDH), or zinc borate. These compounds function by releasing water or forming a char layer upon exposure to high temperatures, thereby impeding combustion and insulating the underlying materials. In some embodiments, halogen-free flame retardant systems are preferred to reduce the production of toxic smoke or corrosive gases during exposure to fire. The polymer matrix itself may be selected from inherently flame-resistant polymers such as polyether ether ketone (PEEK), fluoropolymers, or cross-linked polyethylene (XLPE), which exhibit high thermal decomposition temperatures and reduced flammability.

Additionally, the polymer composition may be cross-linked chemically or through irradiation to improve its dimensional stability under elevated temperatures and mechanical load. The resulting sheath resists softening, deformation, or propagation of cracks when subjected to cutting or fire exposure.

The combination of these additives and reinforcements results in a composite sheath that not only resists mechanical intrusion but also provides enhanced safety and durability in environments where the cable may be exposed to heat, flames, or aggressive physical tampering.

Compressible guide-channel bands (110) are positioned at spaced intervals along the cable length to maintain the circumferential positioning of the armor elements. While two bands are illustrated, it should be understood that any number of bands may be employed, including but not limited to single band configurations, multiple band arrangements exceeding two bands, or continuously distributed band elements. The compressible guide-channel band (110) encircles the armor elements and includes longitudinal guide channels that receive and retain each of the armor elements in their designated circumferential positions. The guide channels may take various forms including but not limited to discrete individual channels, continuous channel formations, loop structures, pocket configurations, or groove arrangements, all of which are contemplated within the scope of the invention.

The compressible guide-channel bands (110) maintain the equidistant spacing of the armor elements around the cable circumference, though non-equidistant arrangements are also contemplated where design requirements dictate alternative spacing patterns. Each band may include individual channels or receptacles that correspond to the positions of the hardened metal elements (112) and aircraft cable elements (116). Alternative embodiments may employ bands with uniform channel configurations adapted to receive any type of armor element, or specialized channel designs optimized for specific armor element types. The bands (110) secure the armor elements against circumferential movement while permitting axial sliding movement along the cable length, though embodiments with restricted or eliminated axial movement are also contemplated within the scope of the invention.

The arrangement shown in system (102) depicted in FIG. 2, demonstrates an alternating pattern of different armor element types around the cable circumference. However, it should be understood that various arrangement patterns are contemplated including but not limited to grouped arrangements, random distributions, asymmetric patterns, or configurations employing three or more distinct armor element types. The hardened metal elements (112) and aircraft cable elements (116) are distributed to provide uniform protection coverage while utilizing materials with distinct mechanical properties to resist various cutting tool types, though embodiments employing uniform armor element materials throughout the circumference are also within the scope of the invention.

The compressible guide-channel bands (110) compress radially inward to accommodate cables of varying diameters while maintaining the organized arrangement of armor elements. Alternative embodiments may employ bands with fixed dimensions, expandable configurations, or adjustable mechanisms including but not limited to mechanical fasteners, adhesive systems, or elastic materials. The compressibility may be achieved through material selection, structural design, or incorporated adjustment mechanisms, all of which are contemplated herein. The bands provide structural support for the armor elements without restricting the flexibility required for normal cable operation and handling, though embodiments with enhanced rigidity or controlled flexibility characteristics are also within the scope of the invention.

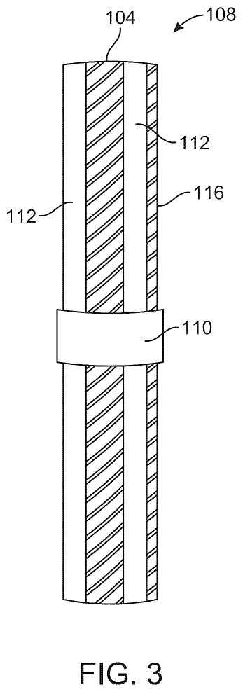

FIG. 3 illustrates a schematic view of the cable protection system showing the internal construction and arrangement of armor elements within a compressible guide-channel band and applied onto a cable (104), in accordance with an embodiment of the present subject matter. This view provides a detailed perspective of how the armor elements are retained and organized within the protective system.

As shown in FIG. 3, the cable (104) extending longitudinally through the center of the protection system. The cable (104) represents the underlying electrical conductor that requires protection from theft or vandalism. While illustrated as a single cable, it should be understood that the system may accommodate multiple cables, cable bundles, or conductors of varying configurations without departing from the scope of the invention.

Hardened metal elements (112) and cables elements (116) may be positioned adjacent to the cable (104) and extend longitudinally along the cable length. The metal elements (112) are disposed in close proximity to the cable surface while maintaining their elongated flat configuration as previously described with reference to FIG. 2.

The compressible guide-channel band (110) encircles the cable (104) and armor elements (112) at an axial location. In one embodiment, the band (110) may incorporate longitudinal guide channels or receptacles that receive and retain the armor elements in their designated positions. While the illustrated embodiment shows a single continuous band, alternative configurations may employ segmented bands, overlapping band sections, or modular band components that assemble around the cable.

The compressible guide-channel band (110) may further include fastening means for securing the band around the cable system. The fastening mechanism may comprise various attachment methods including but not limited to embedded cable ties, mechanical clamps, adhesive systems, hook and loop fasteners, elastic materials, or compression fittings. The fastening means enables the band to compress radially inward to accommodate cables of varying diameters while maintaining secure retention of the armor elements. The armor elements are received within corresponding channels or pockets formed in the band structure, allowing for controlled positioning while permitting axial sliding movement along the cable length. This sliding capability preserves the flexibility characteristics of the underlying cable while maintaining protective coverage.

The band (110) may be constructed from various materials including but not limited to fabric materials, polymer compositions, composite materials, or combinations thereof. The material selection provides the necessary flexibility for installation and operation while offering sufficient strength to retain the armor elements under operational stresses. Alternative embodiments may incorporate reinforcement elements, wear-resistant surfaces, or specialized coatings to enhance durability and performance characteristics.

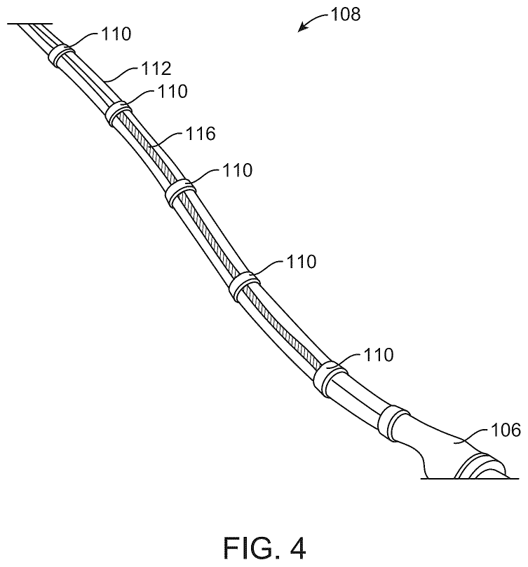

FIG. 4 illustrates a perspective view of the cable protection system (108) in an installed configuration showing the complete system extending along the length of the cable (104) in a curved or bent orientation, in accordance with an embodiment of the present subject matter. This view demonstrates the flexibility characteristics of the protection system and the spatial relationship between multiple compressible guide-channel bands and armor elements along the cable length.

As shown in FIG. 4, the cable (104) extends in a generally curved configuration, demonstrating the flexibility maintained by the protection system during normal cable handling and positioning. The cable (104) exhibits a bend radius that would be typical during installation or operational use, showing that the protection system does not significantly impair the mechanical flexibility of the underlying cable.

Multiple hardened metal elements (112) are visible extending longitudinally along the cable length. These armor elements maintain their parallel orientation to the cable axis while accommodating the curved cable configuration. The metal elements (112) demonstrate the free-floating characteristic that allows the armor elements to slide axially relative to the cable and compressible guide-channel bands during bending operations. This sliding capability prevents the armor elements from restricting cable flexibility or creating stress concentrations that could damage the underlying cable.

Aircraft cable elements (116) are interspersed with the hardened metal elements around the cable circumference. The aircraft cable elements (116) exhibit enhanced flexibility compared to the metal elements, contributing to the overall bend capability of the protection system. Alternative embodiments may employ different ratios of flexible to rigid armor elements, or may incorporate additional armor element types with intermediate flexibility characteristics.

Multiple compressible guide-channel bands (110) are positioned at spaced intervals along the cable length. The spacing between bands allows for the curved configuration shown while maintaining organized positioning of the armor elements. Each band (110) encircles the cable and armor elements at its respective axial location, providing local retention and positioning control. The band spacing may be uniform as illustrated, or may vary along the cable length based on application requirements, anticipated bend locations, or protection priority zones.

The compressible guide-channel bands (110) maintain their generally cylindrical configuration even when the cable is bent, demonstrating the flexibility of the band material and construction. Each band continues to retain the armor elements in their designated circumferential positions while permitting the axial sliding movement necessary for cable bending. Alternative embodiments may employ bands with varying flexibility characteristics, reinforcement patterns, or structural configurations optimized for specific bend radius requirements.

The curved configuration of system (108) illustrated in FIG. 4 represents a typical installation scenario where the cable must navigate around obstacles, follow equipment contours, or accommodate user handling during charging operations. The protection system (108) maintains its protective function throughout the range of cable positions while preserving the operational characteristics of the underlying cable.

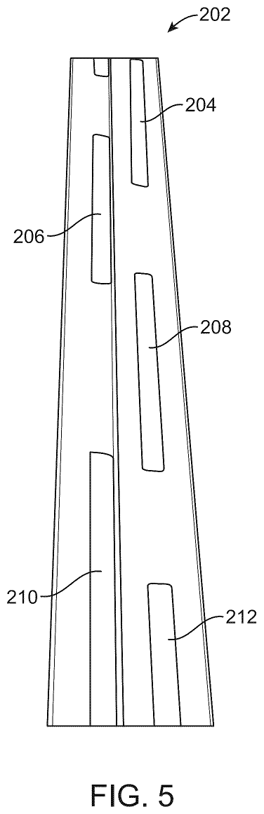

FIG. 5 illustrates an internal view of an outer jacket showing the arrangement and positioning of hardened metal elements within the protective system (108), in accordance with an embodiment of the present subject matter. FIG. 5 provides a perspective view of the armor elements as they would appear when enclosed within the outer jacket structure, demonstrating the organized distribution of protective components.

FIG. 5 depicts an outer jacket (202) that forms an elongated tubular or sleeve structure configured to enclose the armor elements and compressible guide-channel bands. The outer jacket (202) exhibits a generally flat, extended configuration in this view, revealing the internal arrangement of components. While the illustrated embodiment shows the jacket in an opened or flattened state, it should be understood that the jacket may comprise various configurations including but not limited to tubular sleeves, wrap-around designs, split sleeves, or modular enclosure systems.

Multiple hardened metal elements (204, 206, 208, 210, 212) are positioned within the outer jacket (202) and arranged in a generally parallel orientation. The metal elements are disposed longitudinally along the length of the jacket and are spaced at intervals across the width of the jacket structure. The metal elements (204, 206, 208, 210, 212) maintain their elongated strip configuration and demonstrate the flat, ribbon-like profile that characterizes the armor elements. While five metal elements are illustrated, it should be understood that any number of metal elements may be employed, including but not limited to configurations with fewer elements, additional elements, or varying quantities based on protection requirements and cable dimensions.

The hardened metal elements (204, 206, 208, 210, 212) are positioned to provide circumferential coverage when the outer jacket (202) is wrapped around the cable (104). The spacing between adjacent metal elements allows for the accommodation of other armor element types, such as aircraft cable elements, though such elements may not be clearly visible in this particular view. Alternative embodiments may employ uniform spacing between metal elements, variable spacing patterns, or grouped arrangements of armor elements within the outer jacket.

The outer jacket (202) may be constructed from various materials including but not limited to polymer films, fabric materials, composite materials, or combinations thereof. The jacket material provides containment and organization for the armor elements while permitting the flexibility required for cable installation and operation. Alternative embodiments may incorporate reinforcement elements, adhesive systems, or specialized surface treatments to enhance the performance characteristics of the outer jacket.

In an alternative embodiment, longitudinal guide elements or channels may be integrated into the outer jacket (202) to receive and position the armor elements. These guide elements correspond to the compressible guide-channel bands described in previously in the present disclosure and provide organized positioning for the metal elements within the jacket structure. The guide elements may take various forms including but not limited to sewn channels, molded channels, adhesive strips, or mechanical retention features.

The arrangement shown in FIG. 5 (200) demonstrates how the armor elements are systematically organized and retained within the protective system. The metal elements (204, 206, 208, 210, 212) maintain their parallel orientation and predetermined spacing, ensuring consistent protection coverage when the system is installed on the cable (104).

The outer jacket (202) may include closure means for securing the jacket around the cable system during installation. Such closure means may comprise various mechanisms including but not limited to adhesive systems, mechanical fasteners, overlapping seams, or integrated attachment features. The closure system enables the jacket to form a complete enclosure around the armor elements and cable while maintaining the organized arrangement of protective components.

In certain embodiments, the armor elements may be permanently attached to the outer jacket (202) to form an integrated protective sleeve. Such attachment may be achieved through various methods including but not limited to adhesive bonding, mechanical attachment, thermal bonding, or integrated manufacturing processes. Alternative embodiments may employ removable or adjustable attachment systems that permit field modification or replacement of armor elements.

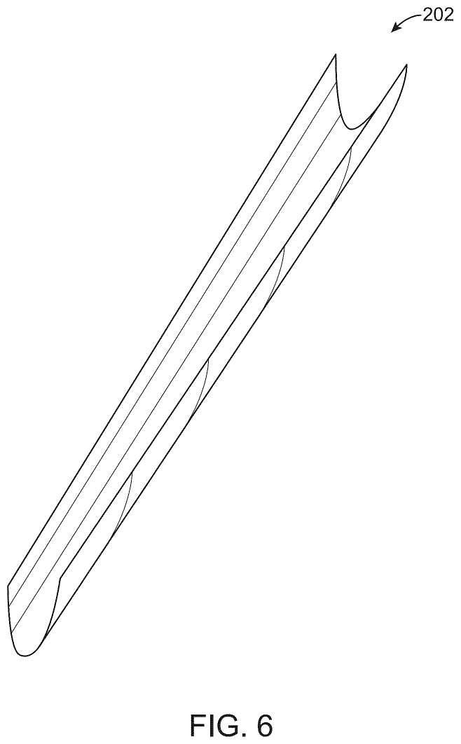

FIG. 6 illustrates the tubular structure of the outer jacket in a partially opened configuration, demonstrating the internal construction and arrangement of armor elements within the protective system (108), in accordance with one embodiment of the present disclosure. The outer jacket (202) is shown in a tubular or sleeve configuration that forms an elongated protective enclosure. The jacket exhibits a generally cylindrical structure when assembled, with the capability to enclose and organize the armor elements and compressible guide-channel bands. In this view, the outer jacket (202) is partially opened or separated to reveal the internal structure and demonstrate the accommodation space for the protective components.

In an alternative embodiment, a pressurized dye reservoir may be disposed along the cable (104) and configured to release dye when breached. The dye reservoir may include a pressurized fluid dye configured to release upon puncture of the reservoir. The dye reservoir may comprise a flexible tube constructed from materials such as braided metal hose, reinforced polymer tubing, or composite constructions. The pressurized fluid dye contained within the reservoir comprises a colored marking solution, such as blue dye, formulated for marking effectiveness and environmental stability. The dye reservoir is pressurized to ensure reliable dye release upon breach of the reservoir structure. The reservoir may be positioned within the protection system (108) using various mounting methods including adhesive attachment, mechanical clamps, or integration within the outer jacket (202). When the protection system is cut, the dye reservoir is punctured, releasing the pressurized dye to mark both the perpetrator and surrounding area for identification purposes.

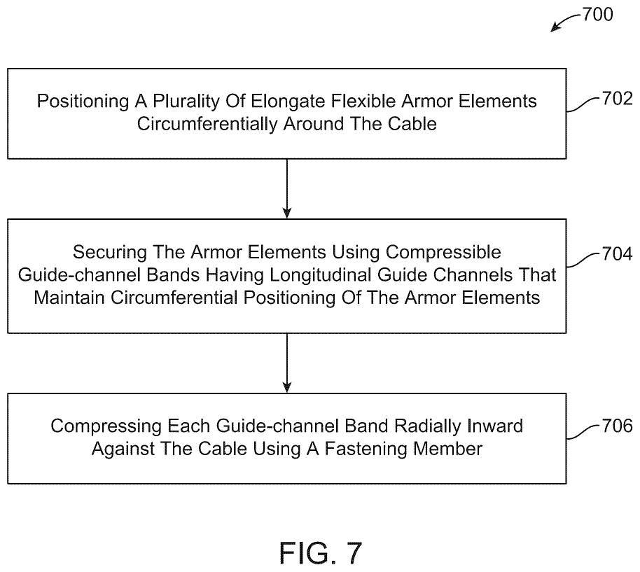

FIG. 7 illustrates a method flow diagram for a method (700) for installing the flexible anti-theft protection system on the cable (104), in accordance with an embodiment of the present subject matter.

The method (700) begins with step (702), which comprises positioning a plurality of elongate flexible armor elements circumferentially around the cable (104). This initial step involves arranging the armor elements, including hardened metal elements (112) and aircraft cable elements (116) as described in previous figures, in their designated circumferential positions around the cable. The armor elements are disposed parallel to the longitudinal axis of the cable and may be arranged equidistantly around the cable circumference as illustrated in FIG. 2 and FIG. 3.

The method proceeds to step (704), which comprises securing the armor elements using compressible guide-channel bands having longitudinal guide channels that maintain circumferential positioning of the armor elements. This step involves installing the compressible guide-channel bands (110) as described in FIGS. 2, 3, and 4, at spaced intervals along the cable length. The securing step ensures that the armor elements maintain their designated positions while permitting axial sliding movement relative to the cable to accommodate bending operations. Multiple guide-channel bands are typically installed along the cable length to provide consistent positioning control, with band spacing that may be uniform or variable based on protection requirements and cable flexibility needs.

The method concludes with step 706, which comprises compressing each guide-channel band radially inward against the cable using a fastening member. This compression step enables the guide-channel bands to accommodate cables of varying diameters while maintaining secure retention of the armor elements in their organized arrangement. The fastening member may comprise various attachment mechanisms including but not limited to embedded cable ties, mechanical clamps, adhesive systems, hook and loop fasteners, elastic materials, or compression fittings. The compression action secures the guide-channel bands around the cable system and ensures proper contact between the protective components and the cable surface. The radial inward compression allows the protection system to accommodate cable diameter variations exceeding 5 mm as specified in the client requirements, while maintaining consistent protection coverage.

Alternative embodiments of the method may include additional steps such as installing an outer jacket (202) over the armor elements and guide-channel bands as shown in FIGS. 5 and 6, or incorporating pressurized dye reservoirs therein. The method may also include preliminary steps such as cable preparation or measurement, and concluding steps such as installation of terminal retention structures.

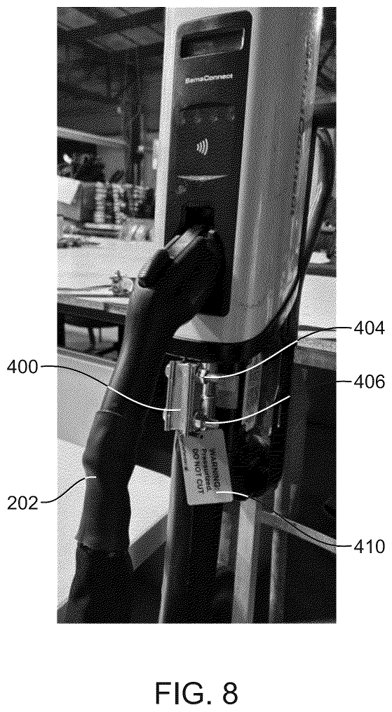

FIG. 8 illustrates the practical implementation of the low-profile clamp (400) positioned at the equipment end of the cable installation, demonstrating the flush termination in accordance with an embodiment of the present subject matter. The photograph shows the protection system (108) installed on a charging cable (104) with the terminal retention structure positioned adjacent to the charging station housing (102).

The low-profile clamp (400) exhibits a compact cylindrical configuration that encircles both the cable (104) and the terminal end of the protection system (108). The clamp body (402) may be constructed from metallic material, likely stainless steel or aluminum alloy for providing the durability and strength required for long-term outdoor installation in charging station environments.

The clamp (400) incorporates multiple fastening elements (404, 406) visible as mechanical fasteners that enable secure tightening around the cable assembly. The fastening system creates uniform circumferential compression, ensuring reliable retention of the protection system without restricting cable flexibility or damaging the underlying cable structure.

The clamp (400) finishes substantially flush with the cable termination features at the charging station housing interface. The clamp profile closely matches the existing cable entry geometry, thereby creating a continuous, integrated appearance that suggests original equipment integration rather than retrofit installation.

The flush termination eliminates protruding elements that could interfere with equipment operation, maintenance access, or present vandalism targets. The smooth transition between the clamp and the equipment housing demonstrates the low-profile design objective achieved in the claimed invention.

FIG. 8 shows the protection system (108) extending from the terminal clamp toward the cable connector end, providing continuous protection coverage along the vulnerable cable length. The protection system maintains uniform cylindrical dimensions throughout its length, confirming the consistent protection coverage claimed in the invention.

The black outer jacket (202) is visible enclosing the internal armor elements and guide-channel bands, demonstrating the integrated protective sleeve configuration. The outer jacket exhibits the flexibility characteristics required for normal cable operation while providing containment and organization for the protective components.

A warning label (410) is prominently displayed on the protection system near the terminal clamp for providing visual deterrent value and legal notice of the security measures in place. The warning label serves as an additional deterrent mechanism while alerting users and maintenance personnel to the presence of the anti-theft protection system.

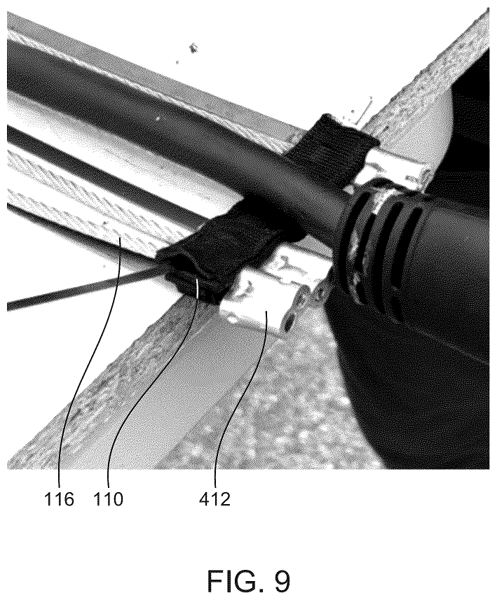

FIG. 9 illustrates provides a detailed view of the terminal retention structure and fastening mechanism, illustrating the integration between the low-profile clamp (400) and the armor element fastening system, in accordance with an embodiment of the present subject matter.

As shown in FIG. 9, fastening elements (412) comprise attachment components integrated with the aircraft cable elements (116). In one embodiment, the fastening elements (412) may work in conjunction with the low-profile clamp (400) to provide the radial compression mechanism that accommodates cables of varying diameters while maintaining secure retention of the protection system components.

The protection system (108) interface with the terminal clamp shows the uniform compression achieved around the cable circumference, confirming proper installation and retention of the internal armor elements and guide-channel bands. The outer jacket (202) exhibits smooth integration with the clamp structure, providing continuous protection coverage up to the terminal retention point.

Although the features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A flexible anti-theft protection system for an elongated cable, comprising:
a plurality of elongate flexible armor elements disposed parallel to a longitudinal axis of the cable and arranged circumferentially around the cable, wherein the armor elements include at least one metal element;
a plurality of guide-channel bands spaced along a length of the cable, each band comprising longitudinal guide channels configured to receive and maintain circumferential positioning of the armor elements; and
wherein the armor elements comprise at least two different materials having distinct mechanical properties.

2. The system of claim 1, wherein the plurality of armor elements are arranged equidistantly around a circumference of the cable.

3. The system of claim 1, wherein the guide-channel bands are compressible and configured to compress radially inward to accommodate cables of varying diameters.

4. The system of claim 3, wherein the at least two different materials comprise hardened steel strips and aircraft cable elements.

5. The system of claim 4, wherein at least four hardened steel strips and at least four aircraft cable elements are arranged in an alternating pattern around the cable circumference.

6. The system of claim 1, further comprising a pressurized dye reservoir disposed along the cable and configured to release dye when breached.

7. The system of claim 6, wherein the dye reservoir comprises a pressurized fluid dye configured to release upon puncture of the reservoir.

8. The system of claim 1, wherein the guide-channel bands permit axial sliding movement of the armor elements relative to the cable to accommodate bending of the cable.

9. The system of claim 1, wherein the armor elements are free-floating within the guide channels to accommodate cable curvature.

10. The system of claim 4, wherein each hardened steel strip has a Rockwell C-scale hardness ranging between 50 to 60 HRC per ASTM E18.

11. The system of claim 1, further comprising terminal retention structures configured at opposite ends of the cable.

12. The system of claim 11, wherein the terminal retention structures comprise: a low-profile clamp positioned at a first end of the cable; and an adhesive-lined heat-shrink boot positioned at a second end of the cable.

13. The system of claim 12, wherein the terminal retention structures finish substantially flush with cable termination features.

14. The system of claim 1, further comprising an outer jacket enclosing the armor elements and guide-channel bands, wherein the armor elements comprise flexible metal strips disposed parallel to the longitudinal axis and the guide-channel bands permit axial sliding movement of the metal strips relative to the cable.

15. The system of claim 14, wherein the metal strips alternate with aircraft-cable wires that are interleaved between adjacent metal strips.

16. The system of claim 14, wherein each guide-channel band further comprises a fastening member for securing the band around the cable.

17. The system of claim 14, wherein the armor elements are permanently attached to the outer jacket to form an integrated protective sleeve.

18. A method of installing an anti-theft protection system on a cable, comprising:
positioning a plurality of elongate flexible armor elements circumferentially around the cable;
securing the armor elements using compressible guide-channel bands having longitudinal guide channels that maintain circumferential positioning of the armor elements; and
compressing each guide-channel band radially inward against the cable using a fastening member.

19. The method of claim 18, wherein the armor elements comprise at least two different materials having distinct mechanical properties.

20. The method of claim 18, further comprising installing an outer jacket over the armor elements and guide-channel bands.
